(19) United States
(12) Patent Application Publication
(10) Pub. No.: US 2012/0062774 A1
(43) Pub. Date: Mar. 15, 2012

(54) ADAPTIVE SOLID STATE IMAGE SENSOR

(75) Inventors: Bryan D. Ackland, Old Bridge, NJ (US); Clifford A. King, Gloucester, MA (US); Conor S. Rafferty, Newton, MA (US)

(73) Assignee: Infrared Newco, Inc., Tucson, AZ (US)

(21) Appl. No.: 13/300,135

(22) Filed: Nov. 18, 2011

Related U.S. Application Data
(63) Continuation of application No. 11/206,555, filed on Aug. 18, 2005, now abandoned.
Application No. 11/206,555 is a continuation-in-part of application No. 10/964,266, filed on Oct. 13, 2004, now Pat. No. 7,643,755.
(60) Provisional application No. 60/510,933, filed on Oct. 13, 2003.

(51) Int. Cl. H04N 5/335

(52) U.S. Cl. 348/300; 348/E05.091

(57) ABSTRACT

An improved monolithic solid state imager comprises plural sub-arrays of respectively different kinds of pixels, an optional filter mosaic comprising color filters and clear elements, and circuitry to process the output of the pixels. The different kinds of pixels respond to respectively different spectral ranges. Advantageously the different kinds of pixels can be chosen from: 1) SWIR pixels responsive to short wavelength infrared (SWIR) in the range of approximately 800-1800 nm; 2) regular pixels responsive to visible and NIR radiation (400-1000 nm) and wideband pixels responsive to visible, NIR and SWIR radiation.

### CROSS REFERENCES TO RELATED APPLICATIONS

The present application is a continuation of U.S. patent application Ser. No. 11/206,555 filed on Aug. 18, 2005 and entitled “Adaptive Solid State Image Sensor,” which is a continuation in part (CIP) of U.S. patent application Ser. No. 10/964,266 filed on Oct. 13, 2004 and entitled “Optical Receiver Comprising a Receiver Photodetector Integrated With an Imaging Array,” which claims the benefit of U.S. Provisional Application No. 60/510,933 filed on Oct. 13, 2003. The foregoing applications are incorporated herein by reference in their entireties.

### GOVERNMENT INTEREST

The United States Government has certain rights in this invention pursuant to NSF Award DMI-0450487.

### FIELD OF THE INVENTION

This invention relates to solid state image sensors and, in particular, to image sensors that can adapt or be adjusted for a wide variety of different lighting conditions ranging from bright daylight to moonless night.

### BACKGROUND OF THE INVENTION

Solid state image sensors (“imagers”) are important in a wide variety of applications including professional and consumer video and still image photography, remote surveillance for security and safety, astronomy and machine vision. Imagers that are sensitive to non-visible radiation, for example infrared radiation, are used in some other applications including night vision, camouflage detection, non-visible astronomy, art conservation, medical diagnosis, ice detection (as on roads and aircraft), and pharmaceutical manufacturing.

A typical image sensor comprises a two-dimensional array of photodetectors (called a focal plane array) in combination with a readout integrated circuit (ROTC). The photodetectors are sensitive to incoming radiation. The ROIC scans and quantitatively evaluates the outputs from the photodetectors and processes them into an image. The ability of the imager to respond to different types of radiation is determined by the spectral response of the photodetectors.

FIG. 1 is a schematic block diagram and approximate physical layout of a typical conventional CMOS silicon imager 10. The imager 10 comprises an n row by an m column array 11 of pixels 12 implemented advantageously on a single silicon die. Each pixel 12 contains a photodetector plus multiplexing circuitry. It can optionally include signal amplification and processing circuitry (pixel components not shown). Each silicon photodetector is responsive to incident visible and near infrared (NIR) radiation. Each pixel generates an output signal that is proportional to the accumulated visible and NIR radiation incident on the photodetector during a defined integration period.

All the pixels 12 in a single row are controlled by a set of row signals generated by a row multiplexer 14. The row multiplexer contains circuits that perform row address and timing functions within the pixel including pixel reset and the length of the integration period. All pixels in a single row output onto a column bus 15 at the same time, but pixels in different rows can output at different times. This staggering allows the pixels in a column to share column bus 15, multiplexing their output signals sequentially onto the column bus one row at a time.

All the pixels 12 in a single column send their output signals to a column multiplexer 17 via the column bus 15. The pixel output signals are multiplexed onto the column bus in response to control signals from the row multiplexer 14. Circuits (not shown) within the column multiplexer can perform a number of functions including amplification, noise reduction and multiplexing into predefined video or image formats, e.g. a standard TV video sequence.

The video or image signals generated by the column multiplexer 17 can be further processed by an image signal processor 18 to reorganize, improve and enhance the image. For example, the image signal processor may detect and highlight edges in the image. Or the processor 18 may adjust the average image intensity by control signals to modify the length of the integration period. Further details concerning the structure and operation of an exemplary conventional imager may be found in Ackland, et al., “Camera on a Chip”, IEEE Int. Solid-State Circuits Conf., February 1996, pp. 22-25, which is incorporated herein by reference.

The imager 10 can be adapted to provide color images by disposing over the pixel array a mosaic of color filters. FIG. 2 illustrates a typical mosaic array 20 of color filters 22R, 22G, and 22B (red, green and blue, respectively). The mosaic array 20 can be an n row by m column array of red, green and blue color filters to be placed over the pixel array 11 such that each color filter covers exactly one pixel 12.

The particular mosaic shown in FIG. 2 distributes the color filters in the well known Bayer pattern. Each 2×2 section of the mosaic consists of two green filters plus one red filter plus one blue filter. With the mosaic in place, each pixel responds to only one color: red, green or blue. Circuits in the image processor 18 can be used to interpret the pixel signal values to generate red, green and blue values for each pixel location and thereby generate a color image. Further details concerning an exemplary color imager can be found in U.S. Pat. No. 3,971,065 issued to B. Bayer in 1976 (“Color Imaging Array”) which is incorporated herein by reference.

While conventional imagers can employ sophisticated electronics to produce high quality images under well defined lighting conditions, they have not proven adaptable to widely differing lighting conditions such as the changes from daylight to dusk to night. Also imagers cannot readily be adapted to applications that require sensitivity in other spectral bands. Conventional imagers like the one shown in FIG. 1 consist of nearly identical pixels which are responsive to only one kind of radiation. For example, an array of silicon pixels is responsive only to visible and NIR radiation.

Color filters may be used to enhance the output of an imager by further limiting the spectral response of individual pixels. This enhancement comes at the cost of reduced sensitivity. With a color filter mosaic, for example, conventional silicon imagers can generate color images under high level illumination, but they exhibit reduced sensitivity and increased noise for moderately low light and, accordingly, are not suitable at dusk or on a moonlit night.

Lower noise monochrome images (e.g. grayscale images) can be obtained by using a monochrome silicon imaging array, i.e. one without a color filter mosaic. But under still lower levels of illumination, e.g. a moonless night, even the monochrome images of silicon arrays become noisy because of the lack of light within the detectable spectral range. Also, such imagers are not capable of detecting short wave infrared (SWIR) radiation as would be required, for example, in an ice detection application.

Accordingly there is a need for improved solid state image sensors that can exhibit sensitivity in a variety of spectral bands to suit the needs of different applications and also can provide high quality images under a wide range of illumination conditions ranging from bright sunlight to moonless night.

### SUMMARY OF THE INVENTION

In accordance with the invention, an improved monolithic silicon solid state imager comprises plural sub-arrays of respectively different kinds of pixels, an optional filter mosaic comprising color filters and clear elements, and circuitry to process the output of the pixels. The pixels referred to herein are preferably active pixels, that comprise both a photodetector and a circuit for amplifying the output of the photodetector. The different kinds of pixels respond to respectively different spectral ranges. Advantageously the different kinds of pixels can be chosen from: 1) SWIR pixels responsive to short wavelength infrared (SWIR) in a range whose lower limit lies between approximately 700 and approximately 1000 nm and whose upper range lies between approximately 1600 and approximately 2500 nm; 2) regular pixels responsive to visible and NIR radiation (400-1000 nm) and 3) wideband pixels responsive to visible, NIR and SWIR radiation.

The different kinds of pixels are advantageously disposed as sub-arrays in a common array in such a way that each sub-array captures a different spectral image of essentially the same scene. The optional filter mosaic is designed so that when it is placed on the imaging array, the combination of different pixel types and different filter elements creates a plurality of sub-arrays that can produce a variety of imaging options. In one embodiment, color filters advantageously overlie regular pixels to provide color imaging in daylight while clear elements overlie SWIR pixels and/or wideband pixels to give enhanced night performance. Alternatively, the clear elements might also overlie regular pixels in order to enhance dusk performance.

The electronics is advantageously adaptable to different lighting conditions and different applications. Upon detection of high levels of illumination, the electronics can preferentially process the output of regular and wideband pixels covered by color filters to produce a color image. Under low levels of illumination, it can preferentially process the output of regular, SWIR and/or wideband pixels that are covered by clear elements to produce a monochrome image with improved signal-to-noise ratio. For applications that require SWIR sensitivity, for example ice or water detection, the electronics can preferentially process the output of some combination of SWIR, regular and wideband pixels to reveal the specific spectral and/or spatial information required by that application.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 is a schematic block diagram and approximate physical layout of a conventional solid state image sensor.

FIG. 2 illustrates a typical mosaic array of color filters useful with sensor of FIG. 1;

FIGS. 3A and 3B are schematic block diagrams of related adaptive solid state image sensors in accordance with a first embodiment of the invention;

FIG. 4 is a schematic block diagram of an adaptive solid state image sensor in accordance with a second embodiment of the invention;

FIG. 5 illustrates a mosaic array of color filters useful with the sensor of FIG. 4;

FIG. 6 is a schematic block diagram of an adaptive solid state image sensor in accordance with a third embodiment of the invention; and

FIG. 7 shows a mosaic array of color filters useful with the sensor of FIG. 6.

It is to be understood that these drawings are for illustrating the concepts of the invention and are not to scale.

### DETAILED DESCRIPTION OF THE PREFERRED EMBODIMENT

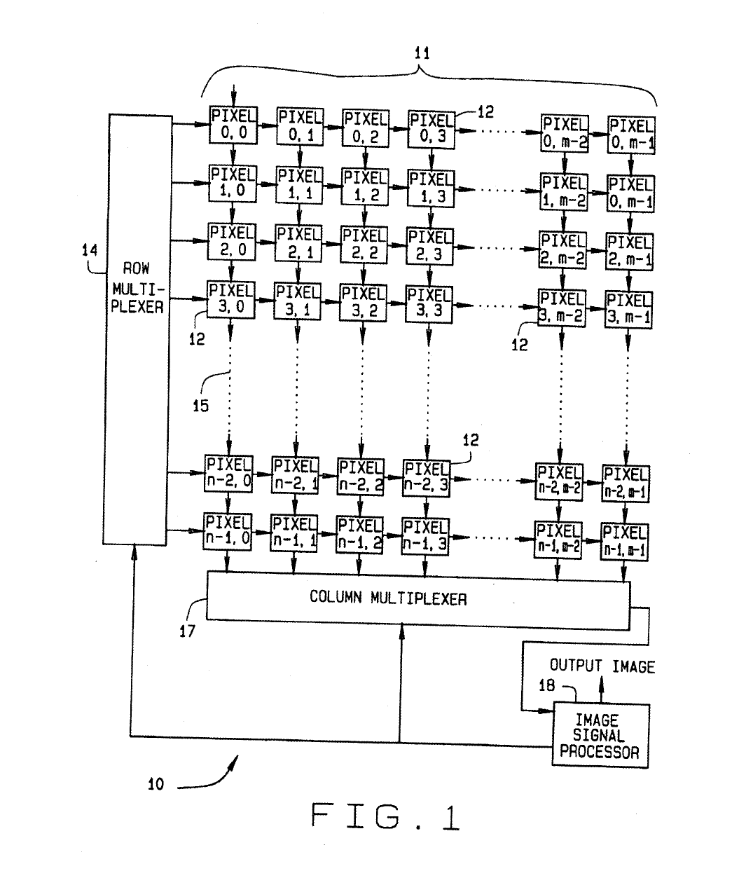

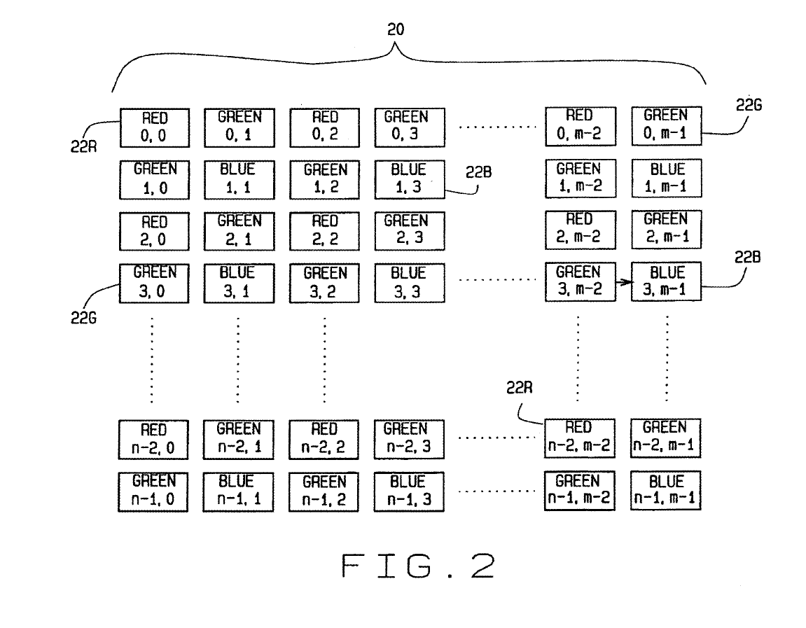

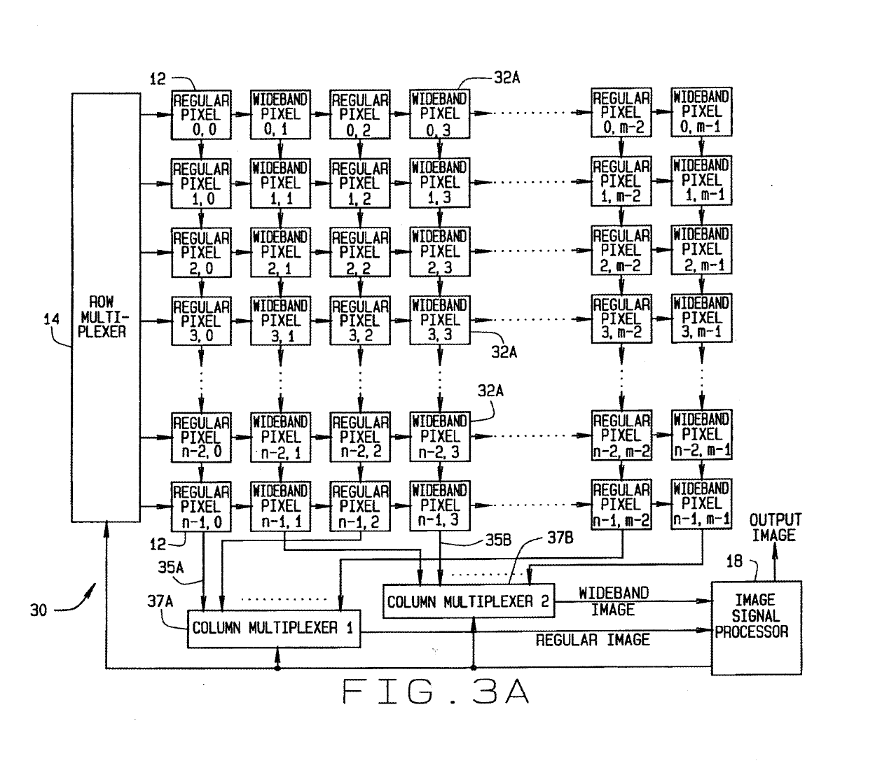

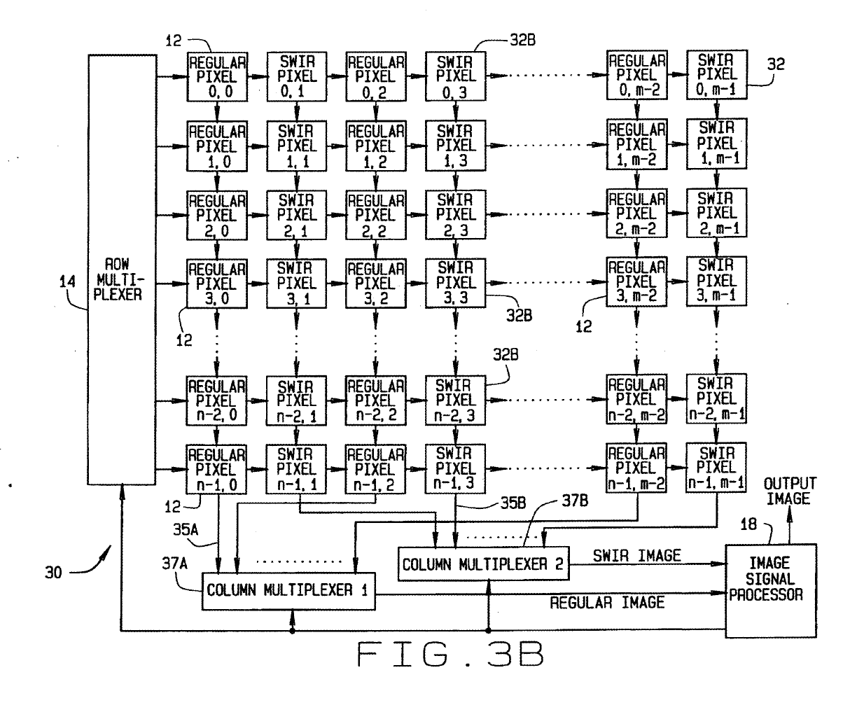

Referring to the drawings, FIG. 3A illustrates a first embodiment of an adaptive solid state imager 30 employing sub-arrays of regular pixels 12 and wideband pixels 32A, respectively. The imaging array shown in FIG. 3A is similar to the one described in FIG. 1 except some of the regular silicon pixels 12 have been replaced by wideband pixels 32A—pixels responsive to visible and short wave infrared radiation. In the particular embodiment shown in FIG. 3A, exactly one half of the pixels are regular pixels 12 and one half of the pixels are wideband pixels 32A, with the two different types arranged in a alternate columns. The n×m array may be viewed as two interleaved n×m/2 sub-arrays, the first sub-array consisting entirely of regular pixels 12, the second sub-array consisting entirely of wideband pixels 32A. The two sub-arrays are nearly spatially coincident, one being displaced from the other by only the size of one pixel dimension in the horizontal direction. When an image is focused onto the imager 30, the two sub-arrays can be used to capture two separate images of what is essentially the same scene.

The column multiplexer shown in FIG. 1 (17) has been replaced by two column multiplexers 37A, 37B. Column bus wires 35A from those columns that contain regular pixels 12 connect to column multiplexer 37A. Column bus wires 35B from those columns that contain wideband pixels 32A connect to column multiplexer 37B.

Each sub-array column multiplexer 37A, 37B will generate its own n×m/2 image. The image signal processor can be used to optionally restore each image to n×m resolution using interpolation techniques well known to those experienced in the art. Since the pixels 12 in the first sub-array are responsive to visible and NIR radiation and not to SWIR radiation, the column multiplexer 37A will generate a visible plus NIR image, named a regular image. Since the pixels 12 in the second sub-array are responsive to wideband radiation, column multiplexer 37B will generate a wideband image. Because of the excellent low-noise and low dark current properties of silicon photodetectors, the regular image will give superior image quality when the scene being imaged is illuminated predominately by visible and NIR radiation as occurs, for example, under daytime or dusk illumination. The second sub-array will give superior image quality when the scene being imaged is illuminated predominantly by SWIR radiation as occurs, for example, under moonless night-time illumination. The image signal processor may select which image to use according to an external control input. Alternatively it may select which image to use according to some measure of the relative signal to noise ratio, for example the relative intensity of each image. Alternatively, it may combine the two images to provide greater resolution or further improved signal to noise ration.

FIG. 3B shows a modification of the FIG. 3A embodiment wherein SWIR pixels 32B replace the wideband pixels 32A. The SWIR pixels are sensitive to only SWIR radiation. While this replacement will give reduced sensitivity under low light conditions, it will allow column multiplexer 37B to generate a SWIR image rather than a wideband image. This substitution will be useful in applications that require processing of the difference between the visible and SWIR images, for example, ice and camouflage detection.

The above-described arrangement of regular pixels and wideband or SWIR pixels and associated circuitry and connections are advantageously integrated into a crystalline semiconductor substrate such as silicon in accordance with techniques well known in the art. The regular pixels are advantageously silicon pixels such as the 3-T pixels described in Ackland et al., “Camera on a chip”, IEEE Intl. Solid State Circuits Conference, February 1996, pp. 22-25, which is incorporated herein by reference. The wide band pixels are advantageously germanium-on-silicon pixels which comprise germanium photodetectors integrated with a silicon substrate and silicon circuitry as described in U.S. patent application Ser. No. 10/453,037 filed by J. Bude et al. on Jun. 3, 2003 (“Semiconductor Devices With Reduced Active Region Defects and Unique Contacting Schemes”). The '037 application claims the benefit of U.S. Provisional Application No. 60/434,359 filed by Bude, et al. on Dec. 18, 2002. application Ser. Nos. 10/453,037 and 60/434,359 are incorporated herein by reference. The SWIR pixels advantageously comprise a germanium-on-silicon wideband pixel in conjunction with a filter element that passes SWIR radiation but blocks visible light.

Note that the two column multiplexers 37A, 37B shown in FIGS. 3A and 3B could be replaced by a single column multiplexer in which the separation of the regular and wideband or SWIR images is performed by circuitry internal to the column multiplexer using techniques well known to those experienced in the art.

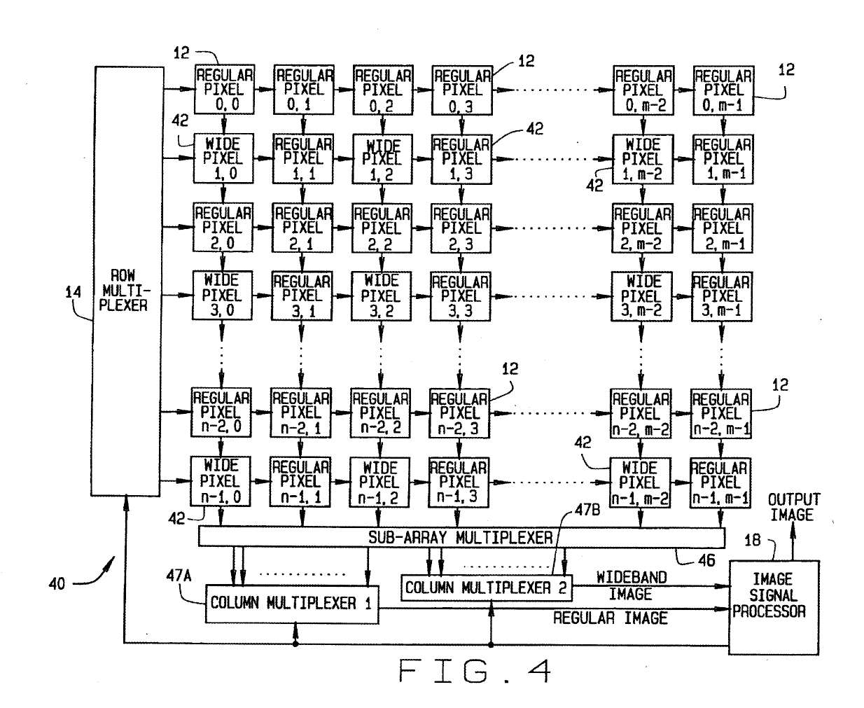

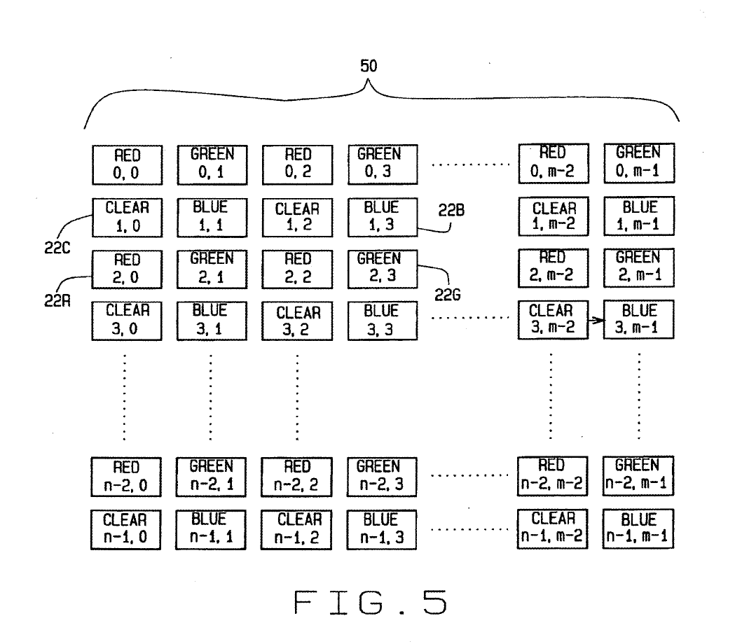

FIG. 4 shows a second embodiment of an adaptive image sensor 40 that can be used in conjunction with the color filter mosaic 50 shown in FIG. 5. In this case, some of the regular pixels 12 of the conventional FIG. 1 device have been replaced by wideband pixels 42—responsive to visible, NIR and SWIR radiation. In the particular embodiment shown in FIG. 4, exactly one quarter of the pixels comprise wideband pixels 42. When the pixels (12, 42) are covered by the color filter mosaic of FIG. 5, each of the wideband pixels 42 is covered by a clear element 22C, whereas the regular pixels are covered by red, green or blue filter (22R, 22G, 22B). The n×m array may be viewed as two interleaved sub-arrays. The first is an n/2×m/2 sub-array consisting entirely of wideband pixels 42 which receive unfiltered radiation through clear elements 22C. The second is an n/2×m/2 sub-array of pixel groups in which each pixel group contains exactly one each of regular pixels 12 covered by respective red, green and blue filters (22R, 22G 22B). Because the two arrays are nearly spatially coincident, they may be used to capture two separate n/2×m/2 images of essentially the same scene.

In this embodiment, a sub-array multiplexer 46 is used to separate pixel outputs and send them to the two separate column multiplexers 47A, 47B according to the particular row being accessed. A control signal from the row multiplexer controls the operation of the sub-array multiplexer 46. For example, when an even row of pixels drive their output signals on to the column bus wires, the sub-array multiplexer will send all signals to multiplexer 47A. When an odd row of pixels drive their output signals on to the column bus wires, the sub-array multiplexer will send signals from even columns to multiplexer 47B, and signals from odd columns to multiplexer 47A.

Column multiplexer 47A thus processes signals from the wideband pixels 42 whereas column multiplexer 47B processes signals from the color filtered regular pixels 12. Using similar techniques to those described for FIG. 3, each column multiplexer combines the signals from its input pixels to form an n/2×m/2 image. The output of column multiplexer 47A will be an n/2×m/2 monochrome image that has high sensitivity and good signal to noise ratio because of the absence of color filters and the wideband response of the detector which extends into the SWIR band. It will provide high quality images even under very low light conditions as may occur, for example, on a moonless night. The output of column multiplexer 47B will be an n/2×m/2 color image with a red, green and blue value at each image location. It will provide good signal- to-noise ratio under high illumination conditions as occurs, for example, in daylight.

The above-described arrangement of regular pixels and associated circuitry and connections are advantageously integrated into a single crystal semiconductor substrate such as silicon or silicon with epitaxially grown germanium. The regular pixels are advantageously the aforementioned 3-T pixels, and the wideband pixels are advantageously the aforementioned germanium-on-silicon pixels.

The image signal processor 18 may be used to restore the resolution of either image, to n×m. Further, the image signal processor may combine the signals from the two sub-arrays to enhance the color fidelity of the color image using known techniques as, for example, described in Henker, S et al, “Concept of Color Correction on Multi-channel CMOS Sensors” Proc. VII^{th} Conf. Digital Image Computing: Techniques and Applications, December 2003, Sydney, pp. 771-780. Alternatively the image processor may use the wideband pixels to produce a pseudo-color image that identifies the presence of infrared-energy in an otherwise color visible image. See Scribner, D. et al, “Melding Images for Information” SPIE OE Magazine, September 2002, pp. 24-26.

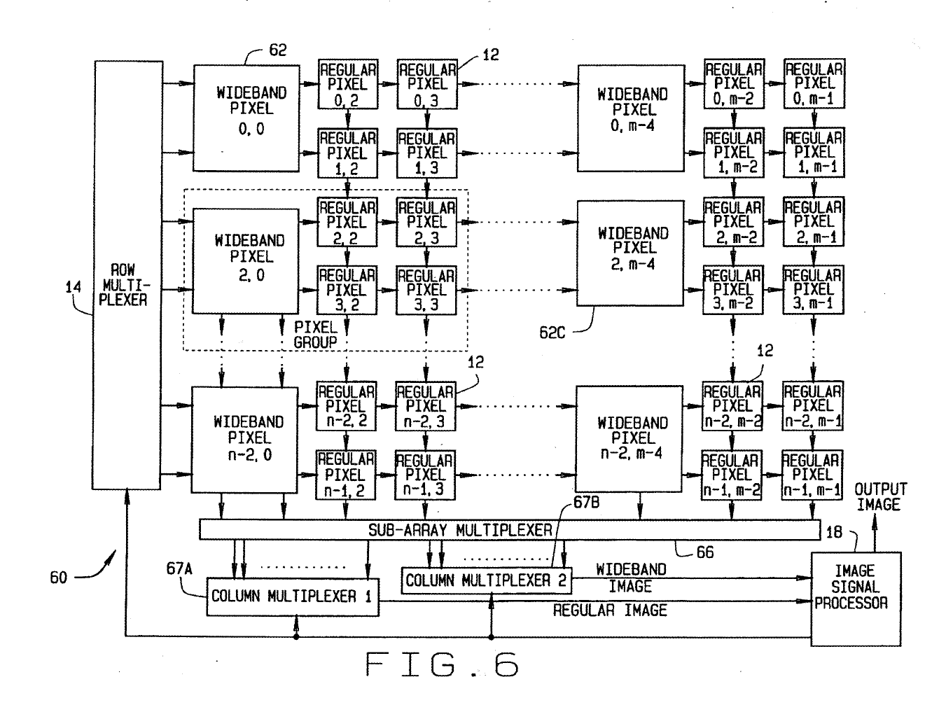

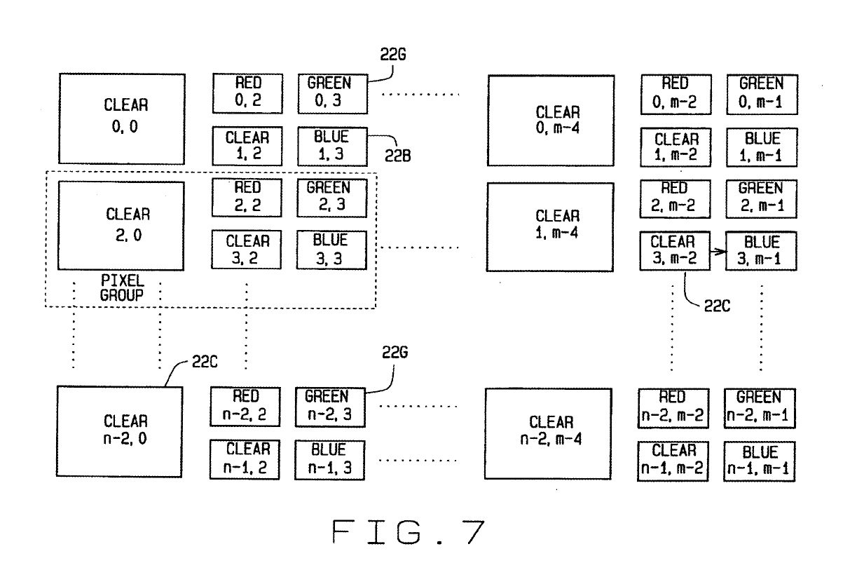

A third embodiment of an adaptive imager 60 is shown in FIGS. 6 and 7. Here the size of the wideband pixel 62 has been increased to improve low light sensitivity. In this case, the n×m array may be viewed as an n/2×m/4 array of pixel groups. Each pixel group contains one wideband pixel 62 which is 2×2 pixel units in size to provide improved sensitivity. The enlarged wideband pixel is covered by an enlarged clear filter element 72C (FIG. 7). The pixel group also contains a 2×2 array of regular pixels 12 of unit size. One of these is covered by a red filter 22R, one by a green filter 22G, one by a blue filter 22B and one by a clear element 22C. A sub-array multiplexer 66 is used to direct the outputs of the wideband pixels to column multiplexer 67A and the outputs of the regular pixels to column multiplexer 67B. Note that each wideband pixel 62 receives two sets of row signals from the row address multiplexer. Only the first of these is used to control the operation of the pixel. It is passed on to the first row of regular pixels that are part of the same pixel group. The second set of row signals is not used by the wideband pixel but simply passed on to the second row of regular pixels in the same pixel group.

Column multiplexer 67A produces an n/2×m/4 wideband image with increased sensitivity due to the much larger wideband pixels for use in very low light conditions.

Column multiplexer 67B produces an n/2×m/4 image with a red, green, blue and white value at each image location.

The image signal processor can use the output of column multiplexer 67B to produce an n/2×m/4 monochrome image using only the white value from each pixel group. This will provide high signal to noise ratio under low light conditions when most of the available radiation is in the visible and NIR bands, as occurs, for example, on a moonlit night. The image signal processor may also use the output of column multiplexer 67B to produce a color image using the output of all four regular pixels at each image location. There are thus three images that may be output from the image signal processor: a wideband monochrome image, a visible and NIR monochrome image and a color image. Once again, the image signal processor 18 may be used to increase the resolution of each of these three images to, for example, n×m using well known interpolation techniques. The image signal processor may also be used to select the best image to view based on overall image intensity or some other measure of image quality. Alternatively, the image processor may use the color image to add limited amounts of color information to one of the monochrome images. More color information would be added under those lighting conditions which generated a higher signal to noise ratio in the color image. Alternatively, the image signal processor may combine the outputs of column multiplexers 67A and 67B to produce a pseudo-color image that identifies the presence of infrared energy in an otherwise visible light color image.

The preferred method of making the image sensors described herein is to fabricate them as silicon and germanium-on-silicon photodetectors on a silicon substrate along with integrated readout circuits. The regular photodetectors as well as the readout circuitry can be fabricated in accordance with techniques well known in the art. The wideband photodetectors can be fabricated by forming germanium photosensitive elements integrated with the silicon substrate and the silicon readout circuits.

The silicon transistors are formed first on a silicon substrate, using well known silicon wafer fabrication techniques. The germanium elements are subsequently formed overlying the silicon by epitaxial growth. The germanium elements are advantageously grown within surface openings of a dielectric cladding. Wafer fabrication techniques are applied to the elements to form isolated germanium photodiodes. Since temperatures needed for germanium processing are lower than those for silicon processing, the formation of the germanium devices need not affect the previously formed silicon devices. Insulating and metallic layers are then deposited and patterned to interconnect the silicon devices and to connect the germanium devices to the silicon circuits. The germanium elements are thus integrated to the silicon by epitaxial growth and integrated to the silicon circuitry by common metal layers.

At each picture element, or pixel, the germanium element converts the incoming illumination into an electrical signal. Circuitry at the pixel detects and amplifies the signal from the germanium element. The pixels are read, as by row and column addressing circuitry, to read out and uniquely identify the output of each pixel. Thus an image is read out from the array. Since germanium is photosensitive from the visible through the infrared up to wavelengths of about 1.8 μm, both visible and infrared images may be formed. The signal from each pixel may be converted from an analog current or voltage to a digital value before being transmitted off-chip. This conversion minimizes signal degradation. In a preferred embodiment, each germanium pixel is epitaxially grown on the silicon as a small crystalline island in a dielectric surface cladding. Further details are set forth in U.S. patent application Ser. Nos. 10/453,037 and 10/964,057 which are incorporated herein by reference.

The SWIR pixels can be fabricated by placing a filter that passes SWIR radiation but blocks visible light on top of wideband pixels. This filter may be applied directly to the wideband pixel or may be incorporated as part of a color mosaic overlay as described earlier.

The three embodiments described are intended to be illustrative of the different ways in which SWIR, wideband and regular pixels may be combined into a two dimensional array and further combined with an optional color filter mosaic to generate a set of images optimized for different lighting conditions and applications. Those experienced in the art will realize other arrangements using different pixel sizes and different layout patterns may provide better performance in other applications. The arrays shown in FIGS. 3A and 3B, for example, could be implemented by interleaving the wideband or SWIR and regular pixels in a diagonal, checkerboard like pattern instead of the orthogonal interleaved pattern shown, to provide reduced aliasing in scenes dominated by horizontal and vertical lines. As another example, the array shown in FIGS. 6 and 7 could be implemented using a Bayer-like pattern, having two green filters, one red and one blue filter above the 2×2 regular pixel array within each pixel group. This would allow better color resolution at the expense of reduced low visible light sensitivity. Also, interleaved arrays of SWIR, wideband and regular pixels could be used with readout technologies other than those shown in FIG. 1. A CCD based serial readout, for example could be used to deliver the individual pixel values to an image signal processor. It is not even necessary that the readout technology be contained on the same die. An array of SWIR, wideband and regular photo-detectors could be bump bonded to a separate die containing pixel processing circuitry using well known techniques as described, for example in Bai, Y et al, “Development of hybrid CMOS visible focal plane arrays at Rockwell”, Proc. SPIE, Vol. 4028, p. 174-182

It can now be seen that, in one aspect, the invention is a solid state, active pixel image sensor comprising a monolithic silicon array of photodetector pixels for producing electrical signals in response to incident radiation and readout circuitry for scanning and processing the pixel outputs into signals corresponding to an image. Each active pixel comprises a photodetector and a circuit for amplifying the output of the photodetector. The array of pixels comprises a first plurality of pixels whose photodetectors are responsive to a first spectral range and a second plurality of pixels whose photodetectors are responsive to a second spectral range different from the first spectral range. The first plurality of pixels and the second plurality of pixels and the associated circuitry of each are monolithically integrated into the same single crystal semiconductor substrate. The pixels of the array are spatially arranged and connected to form a plurality of sub-arrays disposed and arranged to capture essentially the same image.

In one embodiment the pixels of at least one sub-array are responsive to the first spectral range and the pixels in at least another sub-array are responsive to the second spectral range different from the first. The pixels of the sub-arrays can be electrically connected for separate processing of the image signals using individual sub-arrays or for common processing of image signals using plural sub-arrays. The pixels can be electrically connected so that which sub-arrays are used can be switchably controlled.

In one exemplary embodiment, one sub-array comprises regular pixels responsive to visible and near infrared radiation in the range 400-1000 nanometers and another sub-array comprises wideband pixels responsive to visible, NIR and SWIR radiation. Or, in modified form, the wideband pixels can be replaced by SWIR pixels responsive to short wavelength infrared radiation in a range of approximately 800-1800 nanometers.

In another aspect, each sub-array is composed of a plurality of pixels with different pixels respectively responsive to at least two different spectral ranges of radiation. An exemplary embodiment employs, in each array, at least one wideband pixel and at least one regular pixel.

It is to be understood that the above-described embodiments are illustrative of only a few of the many embodiments which can represent applications of the invention. Numerous and varied other arrangements can be made by those skilled in the art without departing from the spirit and scope of the invention.

What is claimed is:

1. An active pixel image sensor comprising:
an array of active pixels for producing electrical output signals in response to incident radiation; and
readout circuitry for scanning the array and processing the electrical output signals;
wherein each active pixel of the array comprises a photodetector and a circuit for amplifying an output of the photodetector;
wherein the array of active pixels comprises a first plurality of pixels whose photodetectors comprise a first material and are responsive to a first spectral range and wherein the array further comprises a second plurality of pixels whose photodetectors comprise a second material different than the first material and are responsive to a second spectral range different from the first spectral range,
wherein the second material comprises germanium and the second spectral range comprises an upper wavelength limit between approximately 1300 nanometers and 2500 nanometers;
wherein at least some pixels of both the first plurality of pixels and the second plurality of pixels are monolithically integrated into a same single crystal silicon substrate; and
wherein the active pixels of the array are spatially arranged and connected to form a plurality of sub-arrays.

2. The image sensor of claim 1 wherein the active pixels of at least one sub-array of the plurality of sub-arrays are responsive to the first spectral range and the active pixels of at least another sub-array of the plurality of sub-arrays are responsive to the second spectral range.

3. The image sensor of claim 1 wherein the active pixels of the plurality of sub-arrays are electrically connected for separate processing of the electrical output signals of the active pixels of the sub-arrays.

4. The image sensor of claim 1 wherein the active pixels of the plurality of sub-arrays are electrically connected for common processing of the electrical output signals of the active pixels of the sub-arrays.

5. The image sensor of claim 1 wherein the active pixels of the plurality of sub-arrays are electrically connected for switchably connecting different sub-arrays of the plurality of sub-arrays for processing a common image.

6. The image sensor of claim 1 wherein the array comprises a rectangular array of linear rows and columns of pixels.

7. The image sensor of claim 6 wherein the sub-arrays of the plurality of sub-arrays comprise interleaved rows or columns of pixels.

8. The image sensor of claim 1 wherein the array comprises a rectangular array of linear rows and columns of pixel groups where each pixel group contains at least one pixel from each sub-array.

9. The image sensor of claim 1 wherein the photodetectors of the first plurality of pixels have an upper wavelength detection limit in the visible or near infrared spectrum.

10. The image sensor of claim 1 wherein the plurality of sub-arrays comprises one or more sub-arrays chosen from the group consisting of: sub-arrays of pixels responsive to short wavelength infrared radiation in the range of approximately 800-1800 nanometers, sub-arrays of pixels responsive to visible and near infrared radiation in the range of approximately 400-1000 nanometers and sub-arrays of pixels responsive to visible, near infrared and short wave infrared radiation in the range of approximately 400-1800 nanometers.

11. The image sensor of claim 1 wherein the first material is silicon and the second material is single crystal germanium.

12. The image sensor of claim 1 wherein the second material is single crystal germanium.

13. The image sensor of claim 1
wherein the first plurality of pixels comprises photodetectors responsive to visible and near infrared radiation in the range of approximately 400-1000 nanometers and the second plurality of pixels comprises photodetectors responsive to short wavelength infrared radiation in the range of approximately 800-1800 nanometers.

14. The image sensor of claim 13 further comprising a mosaic of color filters and clear elements disposed in a path between the incident radiation and one or more active pixels of the array.

15. The image sensor of claim 13 wherein the photodetectors of the second plurality of pixels comprise single crystal germanium.

16. A solid state image sensor comprising:
an array of photodetector pixels for producing electrical output signals in response to incoming radiation, the photodetector pixels being monolithically integrated into a same silicon semiconductor substrate; and
readout circuitry for scanning the array and processing the electrical output signals of the photodetector pixels;
wherein the array of photodetector pixels comprises at least two sub-arrays, each sub-array comprising a plurality of photodetector pixels,
wherein the photodetector pixels of a first sub-array of the at least two sub-arrays have photodetectors responsive to a first spectral range of radiation and wherein the photodetector pixels of a second sub-array of the at least two sub-arrays have photodetectors comprising germanium and responsive to a second spectral range of radiation different than the first spectral range of radiation;
wherein the first sub-array of the at least two sub-arrays comprises photodetector pixels responsive to visible and near infrared radiation in the range of approximately 400-1000 nanometers and the second sub-array of the at least two sub-arrays comprises photodetector pixels responsive to visible, near infrared and shortwave infrared radiation in the range of approximately 400-1800 nanometers.

17. The image sensor of claim 16, further comprising a mosaic of color filters and clear elements disposed in a path between incident radiation and the array of photodetector pixels.

18. The image sensor of claim 16, wherein the first sub-array comprises a plurality of different types of photodetector pixels responsive to different spectral ranges of radiation.

19. The image sensor of claim 18, wherein at least some photodetector pixels of the first sub-array include a color filter.

20. The image sensor of claim 16, wherein the pixels of the first sub-array and the pixels of the second sub-array are arranged in a checkerboard pattern.

21. The image sensor of claim 16, wherein the photodetector pixels of the second sub-array of the at least two sub-arrays have photodetectors comprising single crystal germanium.

22. The image sensor of claim 21, wherein the photodetector pixels of the first sub-array have silicon photodetectors.
